(19) United States
(12) Patent Application Publication
(10) Pub. No.: US 2019/0235344 A1
(43) Pub. Date: Aug. 1, 2019

(54) DISPLAY PANEL AND DISPLAY DEVICE

(71) Applicant: BOE Technology Group Co., Ltd., Beijing (CN)

(72) Inventors: Hao MIAO, Beijing (CN); Pengju ZHANG, Beijing (CN); Mingxing LIU, Beijing (CN); Hong ZHU, Beijing (CN); Haiyan SUN, Beijing (CN)

(21) Appl. No.: 16/205,689

(22) Filed: Nov. 30, 2018

(30) Foreign Application Priority Data
Jan. 30, 2018 (CN) 201810091464.6

(51) Int. Cl. G02F 1/169; G02F 1/00; G02F 1/01

(52) U.S. Cl. CPC G02F 1/169; G02F 1/0102; G02F 1/0063

(57) ABSTRACT

The present disclosure provides a display panel and a display device. The display panel includes a first substrate and a second substrate which are aligned with each other, and a dispersion containing a two-dimensional material arranged between the first substrate and the second substrate. The display panel provided by the present disclosure can achieve a different gray scale display and thus may replace liquid crystal display.

### CROSS REFERENCE TO RELATED APPLICATION

This application claims the benefit of Chinese Patent Application No. 201810091464.6, filed on Jan. 30, 2018, entitled “DISPLAY PANEL AND DISPLAY DEVICE”, which is hereby Incorporated by reference in its entirety into this application.

### TECHNICAL FIELD

The present disclosure relates to the field of display technology, and in particular, to a display panel and a display device.

### BACKGROUND

At present, a liquid crystal display (LCD) is formed by injecting liquid crystals between two layers of substrates. An electric field can be formed by applying a voltage to the substrates, and liquid crystal molecules are deflected under the resultant action of the electric field and a gravity field, thereby realizing gray scale control.

The present disclosure provides a display panel that can replace the liquid crystal display to achieve different gray scale displays.

### SUMMARY

The present disclosure aims to at least solving one of the technical problems existing in the prior art, and proposes a display panel and a display device, which could replace liquid crystal display to achieve a different gray scale display.

To achieve the above purpose, the present disclosure provides a display panel including a first substrate and a second substrate which are aligned to each other, and a dispersion comprising a two-dimensional material which is arranged between the first substrate and the second substrate, and the light transmittance of the dispersion would be changed depending on an applied electric field so as to achieve a different gray scale display.

Optionally, a supporting material is arranged between the first substrate and the second substrate. The supporting material divides a space between the first substrate and the second substrate into a plurality of mutually independent sub-spaces, and each of the sub-spaces corresponds to one pixel unit.

Optionally, the concentration of the dispersion is a preset first concentration; and the deflecting direction of the two-dimensional material is controlled by the direction and the intensity of a total electric field which includes a horizontal electric field parallel to a plane where the substrate is located, and a vertical electric field vertical to the plane where the substrate is located.

Optionally, in each sub-space, a first electrode is arranged on a surface of the first substrate adjacent to the dispersion, and a second electrode is arranged on a surface of the second substrate adjacent to the dispersion, wherein the first electrode is opposite to the second electrode and the first and second electrodes are used for generating the vertical electric field; and

the second electrode includes a pair of sub-electrodes arranged at an interval in a direction parallel to the plane where the second substrate is located and the sub-electrodes are used for generating the horizontal electric field.

Optionally, in each sub-space, a pair of first electrodes are oppositely arranged on a surface of the first substrate adjacent to the dispersion and a surface of the second substrate adjacent to the dispersion and the first electrodes are used for generating the vertical electric field; and a pair of second electrodes are oppositely arranged on the supporting material corresponding to the sub-space and the second electrodes are used for generating the horizontal electric field.

Optionally, a diffusion layer is arranged on one side of the first substrate away from the dispersion.

Optionally, the first concentration is less than 1% by volume.

Further, the first concentration is less than or equal to 0.1% by volume.

Optionally, the concentration of the dispersion is a preset second concentration; and the birefringence of the two-dimensional material is controlled by the Intensity of the applied electric field which includes a horizontal electric field parallel to a plane where the substrate is located.

Optionally, in the display panel, a first polarizing film is arranged on a surface of the first substrate away from the dispersion; and a second polarizing film is arranged on a surface of the second substrate away from the dispersion.

Optionally, in each sub-space, a second electrode including a pair of sub-electrodes is arranged on a surface of the second substrate adjacent to the dispersion and the second electrode for generating the horizontal electric field, wherein the pair of sub-electrodes are arranged at an interval in a direction parallel to the plane where the second substrate is located.

Optionally, the second concentration is greater than 1% by volume.

Further, the second concentration is greater than 2.7% by volume.

Optionally, the two-dimensional material Includes graphene oxide or graphene.

Optionally, the space between the first substrate and the second substrate has a thickness in the range of 20-40 μm.

Optionally, the first substrate is a color film substrate; and the second substrate is an array substrate.

As another technical solution, the present disclosure further provides a display device including the above display panel provided by the present disclosure.

### BRIEF DESCRIPTION OF THE DRAWINGS

FIG. 1 is a partial section view of a display panel provided according to an embodiment of the present disclosure;

FIG. 2A is a schematic diagram of the liquid crystal property of graphene oxide;

FIG. 2B is an arrangement comparison diagram of graphene oxide before and after applying an electric field;

FIG. 2C is a schematic diagram of arrangement of graphene oxide along the direction of the electric field;

FIG. 3 is another partial section view of a display panel provided according to an embodiment of the present disclosure;

FIG. 4 is yet another partial section view of a display panel provided according to an embodiment of the present disclosure;

FIG. 5 is yet another partial section view of a display panel provided according to an embodiment of the present disclosure;

FIG. 6A is a partial section view of a display panel provided according to another embodiment of the present disclosure;

FIG. 6B is another partial section view of a display panel provided according to another embodiment of the present disclosure.

### DETAILED DESCRIPTION OF CERTAIN EMBODIMENTS

In order that those skilled in the art can better understand the technical solutions of the present disclosure, a display panel and a display device provided by the present disclosure are described in detail below with reference to the drawings.

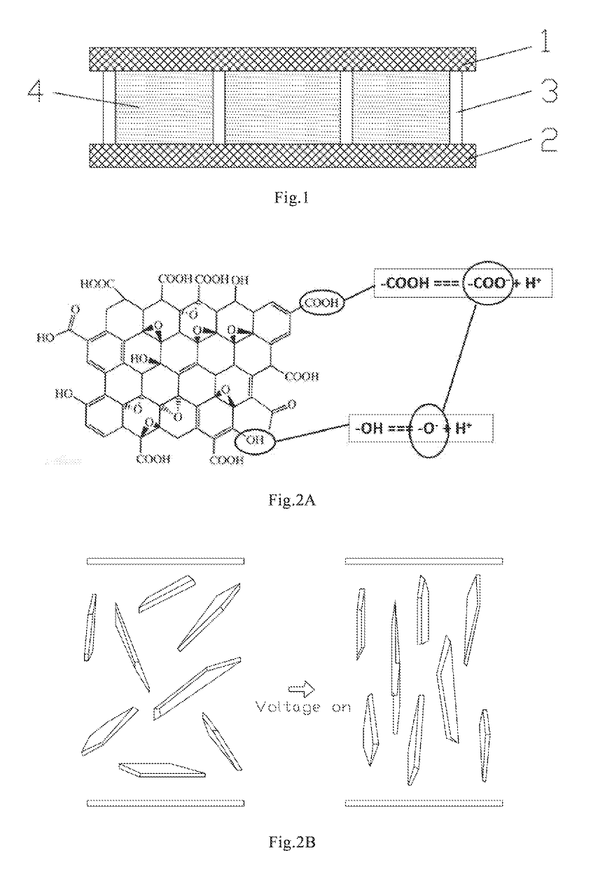

Referring to FIG. 1, a display panel provided according to an embodiment of the present disclosure includes a first substrate 1 and a second substrate 2 which are aligned to each other, and a dispersion containing a two-dimensional material which is arranged between the first substrate 1 and the second substrate 2, wherein the light transmittance of the dispersion could be changed depending to an applied electric field so as to achieve a different gray scale display.

The two-dimensional material may include graphene oxide, graphene, boron nitride (BN), molybdenum disulfide (MoS₂) or the like. Optionally, the two-dimensional material is made of graphene oxide which is an oxide of graphene.

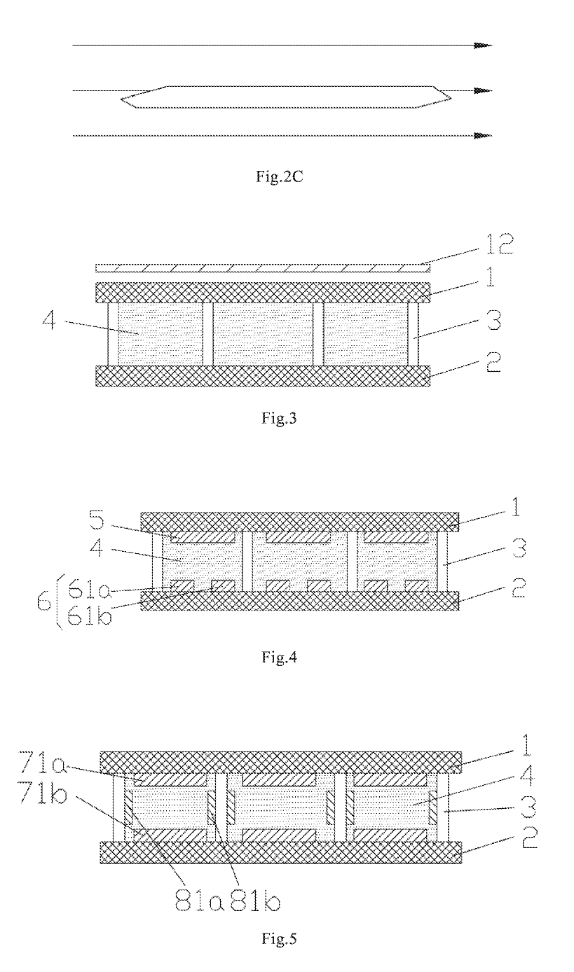

As shown in FIG. 2A, after the graphene is oxidized, since the contained oxygen-containing functional groups are increased, the graphene oxide is more active than the graphene.

When the concentration of the dispersion is less than 1%, the two-dimensional material is isotropic. In other words, the graphene oxide flakes are arranged approximately parallel in the long axis direction thereof. In the dispersion having the low-concentration of the two-dimensional material, when the two-dimensional material is affected by the electric field, since the electric field force is much larger than the intermolecular force, the electric field force plays a leading role. Under the action of the electric field force, an electronegative group on the surface of the two-dimensional material generates electric induction, thereby generating surface current on the surface of the two-dimensional material, so that the two-dimensional material is deflected and is arranged along the direction of the electric field.

As shown in FIG. 2B, the arrangement of the graphene oxide flakes in the long axis direction thereof is chaotic before the application of the electric field. As shown in FIG. 2C, after applying the electric field, the surface current is generated on the surfaces of the graphene oxide flakes along the long axis direction, so that the graphene oxide flakes are deflected and are arranged approximately in parallel along the long axis direction thereof. The two-dimensional materials at different positions in the electric field are subjected to different attractive forces or repulsive forces and then the deflection angles of the two-dimensional materials may be different, so that the deflection angles of the two-dimensional materials can be controlled by the intensity and the direction of the applied electric field.

When the concentration of the dispersion is greater than 1%, the two-dimensional material is arranged in a nematic phase and has birefringence to deflect the linearly polarized light. For example, hydroxyl groups and carboxyl groups on the surface of the graphene oxide have weak electronegativity in the dispersion, and the electrostatic repulsive force between the molecules causes the dispersion of graphene oxide to be arranged in the nematic phase, which is similar to nematic phase liquid crystal. When being affected by the electric field, the molecules are still arranged in the nematic phase because the electric field force is not sufficient to break the intermolecular force. However, the birefringence of the two-dimensional material changes with the intensity of the electric field.

Based on the above characteristics of the two-dimensional material such as the graphene oxide flakes, the light transmittance of the dispersion can be controlled by the applied electric field so as to realize different gray scale displays, which could replace the liquid crystal display.

The structure of the display panel provided according to an embodiment of the present disclosure will be described in detail as below.

As shown in FIG. 1, a supporting material 3 is arranged between the first substrate 1 and the second substrate 2, and the supporting material 3 divides the space between the first substrate 1 and the second substrate 2 into a plurality of mutually Independent sub-spaces 4, wherein each of the sub-spaces 4 corresponds to one pixel unit. The above dispersion is filled in each of the sub-spaces 4. Thus, the dispersion liquid in the sub-spaces 4 are isolated from each other, and the independent control of the gray scale display of each pixel unit can be realized by independently controlling the light transmittance of the dispersion in the sub-spaces 4.

In the case that the concentration of the dispersion is a first concentration, the two-dimensional material is isotropic. The first concentration is less than 1% by volume. Optionally, the first concentration is less than or equal to 0.1% by volume. When the concentration of the two-dimensional material in the dispersion is the first concentration, the electric field force is much greater than the intermolecular force, so that the electric field force plays the leading role, and in this way, the two-dimensional material is deflected and is arranged along the direction of the electric field. The Intensity of the applied electric field depends on the thickness of the dispersion and the arrangement of the electrodes.

In this case, the deflecting direction of the two-dimensional material is controlled by the intensity and the direction of the applied electric field which Includes a horizontal electric field parallel to a plane where the substrate is located and a vertical electric field vertical to the plane where the substrate is located, wherein the horizontal electric field and the vertical electric field is controlled to form different surface currents on the surface of the two-dimensional material. When the intensity of the vertical electric field is larger than that of the horizontal electric field, the deflection of the two-dimensional material in the dispersion will occur. The larger the Intensity of the vertical electric field is, the nearer the two-dimensional material to the vertical direction is. That is, the control of light flux is realized in a physical deflection mode, thereby realizing different gray scale displays. For example, when the two-dimensional material is arranged along the direction of the electric field, the dispersion is opaque and the display panel is in a dark state. When the two-dimensional material is arranged along a direction vertical to the electric field, the degree of light transmittance (light flux) of the dispersion is up to the maximum and the brightness of the display panel is maximum. When the two-dimensional material in each of the sub-spaces forms different angles with the direction of the electric field, the degrees of light transmittance of the dispersion are different, thereby achieving different gray scale displays.

In the case that the concentration of the dispersion is a preset first concentration, transparent display can be realized, and different gray scale displays can be realized without using a polarizing film, so that the thickness of the display panel can be reduced.

Moreover, since the dispersion having the low-concentration of the two-dimensional material can realize the control of the light flux in a physical deflection manner, the display panel using the dispersion can have a great application prospect in the fields of light transmittance display, transflective display, reflective display, transparent display, etc.

The so-called transmittance display refers to display in the case that the dispersion is light-permeable, and the viewer see the display on an opposite side of a light emitting side of the display panel. The so-called reflective display refers to display in the case that the dispersion is opaque, and this display panel is similar to the reflection of a mirror which can receive image signals on the same side of the light incidence side of the display panel and display the image signals. The so-called transflective display refers to that the reflective display plays the leading role in the case of strong ambient light, and the light transmittance display plays the leading role in the case of weaker ambient light. In other words, different display modes can be switched according to ambient light. The so-called transparent display is similar to displaying an image on transparent glass. In summary, when the concentration of the dispersion is the preset first concentration, various display principles can be realized, thereby expanding the application field of the display panel.

Optionally, as shown in FIG. 3, a diffusion layer 12 is arranged on a side of the first substrate 1 away from the dispersion, and the diffusion layer 12 is used for reducing the viewing angle limitation caused by the two-dimensional material, thereby increasing the visual angle.

In the case that the concentration of the dispersion is the first concentration, in order to accurately control the spatial existence state of the two-dimensional material, the applied external electric field includes the horizontal electric field and the vertical electric field. The structure of an electrode capable of generating the electric field described above will be described in detail as below.

As shown in FIG. 4, in each of the sub-spaces 4, a first electrode 5 is arranged on a surface of the first substrate 1 adjacent to the dispersion, a second electrode 6 is arranged on a surface of the second substrate 2 adjacent to the dispersion, wherein the first electrode 5 is opposite to the second electrode 6 so as to generating the vertical electric field; and the second electrode 6 includes a pair of sub-electrodes (61a, 61b) arranged at an Interval along a direction parallel to the plane where the second substrate 2 is located so as to generating the horizontal electric field. The direction and the intensity of the applied electric field can be controlled by respectively controlling voltage values applied to the first electrode 5 and the second electrode 6. Both of the first electrode 5 and the second electrode 6 can be made of a transparent material such as ITO.

The space between the first substrate 1 and the second substrate 2 has a thickness in the range of 20-40 μm. Therefore, the thickness of the layer where the two-dimensional material is located is significantly reduced relative to the thickness of the traditional liquid crystal layer, so that the thickness of the display panel can be greatly reduced.

If the two-dimensional material is graphene oxide, the preparation method of the dispersion can specifically adopt an improved Hummers method. Specifically, a mixture of concentrated sulfuric acid and concentrated phosphoric acid with a ratio of 9:1 is adopted, and potassium permanganate is added therein to oxidize graphite flakes. A brown graphite flake is obtained by an oxidation reaction between the potassium permanganate and graphite powder, a derivative carboxylic acid group is on the edge of the graphite flakes, and phenolic hydroxyl groups and epoxy groups are mainly on the surface of the graphite flakes. The graphite flakes are stripped into graphene oxide by ultrasonic or high shear vigorous stirring, and a stable and light claybank monolayer graphene oxide suspension is formed in water, such that the preparation of the dispersion of graphene oxide is completed. The preparation method has the advantages of relatively good timeliness and safety.

In addition, surface modification can also be performed on the graphene oxide with ions. For example, the graphene oxide is modified in a physical or chemical method such as doping or surface coating and the like to improve the absorbance and the control degree of the electric field.

The first substrate 1 may be a color film substrate; and the second substrate 2 may be an array substrate.

It should be noted that, in the present embodiment, the first electrode 5 is arranged opposite to the second electrode 6, and the second electrode 6 is composed of a pair of sub-electrodes (61a, 61b), but the present disclosure is not limited to the use of the above electrode structure. For example, the electrode structure can also be set in the way as shown in FIG. 5, i.e. in each of the sub-spaces 4, a pair of first electrodes (71a, 71b) is respectively arranged on a surface of the first substrate 1 adjacent to the dispersion and a surface of the second substrate 2 adjacent to the dispersion for generating the vertical electric field; and moreover, and a pair of second electrodes (81a, 81b) is oppositely arranged on the supporting material corresponding to each of the sub-spaces 4 for generating the horizontal electric field. The electric field generated by the electrode structure controls the deflecting direction of the two-dimensional material more accurately. Of course, other electrode structures capable of generating the horizontal electric field and the vertical electric field can be used in practical application.

A display panel provided by another embodiment of the present disclosure is substantially the same as the display panel provided by the above embodiment except for the concentration of the dispersion and the electrode structure that generates an external electric field. The difference between the present embodiment and the above embodiment will be described in detail as below.

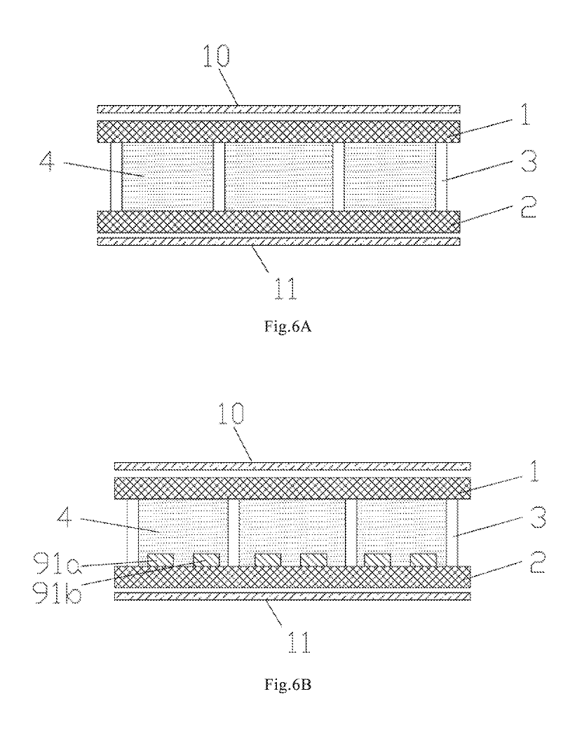

As shown in FIG. 6A, in the case that the concentration of the dispersion is a second concentration, the two-dimensional material is arranged in a nematic phase and has birefringence. The second concentration means that the concentration of the two-dimensional material in the dispersion is greater than 1% by volume. Optionally, the second concentration is greater than 2.7% by volume. When the concentration of the two-dimensional material in the dispersion is the second concentration, the electric field force is insufficient to break the intermolecular force, and thus the molecules are still arranged in the nematic phase. However, the birefringence of the two-dimensional material could be changed by the intensity of the electric field.

Since the two-dimensional material is arranged in the nematic phase, the deflection angle of the two-dimensional material only needs to be controlled by using the horizontal electric field parallel to the plane where the substrate is located, thereby realizing different birefringence. At this time, the characteristics of the two-dimensional material are similar to the characteristics of the liquid crystal, and the polarized light can be deflected. This principle is similar to the advanced super dimension switch (Advanced Super Dimension Switch, referred to as ASDS), that is, the two-dimensional material is deflected by the horizontal electric field generated by the electrodes in the same plane so as to realize image display.

The distribution of the two-dimensional material satisfies the Kerr effect (i.e., the electric induction birefringence phenomenon which is proportional to the square of the electric field strength), so that the deflection direction of the two-dimensional material could be controlled by the intensity of the electric field, thereby controlling the light transmittance of the dispersion. For example, the direction of the two-dimensional material is parallel with the light-emitting direction; the light transmittance reaches the maximum.

Optionally, a first polarizing film 10 is arranged on a surface of the first substrate 1 away from the dispersion; and a second polarizing film 11 is arranged on a surface of the second substrate 2 away from the dispersion. The roles of the first polarizing film 10 and the second polarizing film 11 are the same as those of the two polarizing films in the liquid crystal display.

Therefore, in the case that the concentration of the dispersion is the second concentration, the same effect as the liquid crystal can be exerted, but the thickness is remarkably reduced, thereby reducing the thickness of the display panel. Moreover, the display panel using the dispersion can have a great application prospect in the fields of light transmittance display, transflective display, reflective display, transparent display, etc.

The electrode structure capable of generating the horizontal electric field will be described in detail as below. As shown in FIG. 6B, in each of the sub-spaces 4, a second electrode is arranged on a surface of the second substrate 2 adjacent to the dispersion, wherein the second electrode includes a pair of sub-electrodes (91a, 91b) arranged at an interval along a direction parallel to the plane where the second substrate 2 is located so as to generate the horizontal electric field.

It should be noted that, in the present embodiment, the second electrode is composed of a pair of sub-electrodes (91a, 91b), but the present disclosure is not limited thereto, an electrode of any other structure can also be adopted in the actual application, as long as the horizontal electric field can be generated. For example, an Interdigital electrode (a plurality of sub-electrodes) may be provided.

Other structures of the display panel provided by the present embodiment are the same as those of the display panel provided in the above embodiment, and are not described herein again.

In summary, the display panel according to various embodiments of the present disclosure includes the first substrate and the second substrate which are aligned with each other, and the dispersion containing the two-dimensional material arranged between the first substrate and the second substrate, so that a different gray scale display can be realized by controlling the light transmittance of the dispersion through the applied electric field, which could replace the liquid crystal display.

As another technical solution, other embodiments of the present disclosure further provide a display device, including the display panel provided by the various above embodiments of the present disclosure.

The display device provided by the embodiment of the present disclosure can replace the liquid crystal display to realize different gray scale displays by using the display panel provided by the various above embodiments of the present disclosure.

It can be understood that the above embodiments are merely exemplary embodiments used for illustrating the principles of the present disclosure, but the present disclosure is not limited thereto. Various modifications and improvements can be made by those of ordinary skill in the art without departing from the spirit and essence of the present disclosure, and these modifications and improvements are also considered as the protection scope of the present disclosure.

1. A display panel, comprising a first substrate and a second substrate which are aligned with each other, and a dispersion containing a two-dimensional material arranged between the first substrate and the second substrate, wherein the light transmittance of the dispersion of the two-dimensional material is changed depending on an applied electric field so as to achieve a different gray scale display.

2. The display panel according to claim 1, wherein a supporting material is arranged between the first substrate and the second substrate which divides a space between the first substrate and the second substrate into a plurality of mutually independent sub-spaces, and each of the sub-spaces corresponds to one pixel unit.

3. The display panel according to claim 2, wherein the concentration of the dispersion is a preset first concentration; and
the deflecting direction of the two-dimensional material is controlled by the direction and the intensity of the applied electric field which comprises a horizontal electric field parallel to a plane where the substrate is located and a vertical electric field vertical to the plane where the substrate is located.

4. The display panel according to claim 3, wherein in each of the sub-spaces, a first electrode is arranged on a surface of the first substrate adjacent to the dispersion, a second electrode is arranged on a surface of the second substrate adjacent to the dispersion, wherein the first electrode is arranged opposite to the second electrode so as to generate the vertical electric field; and
the second electrode comprises a pair of sub-electrodes arranged at an interval in a direction parallel to the plane where the second substrate is located so as to generate the horizontal electric field.

5. The display panel according to claim 3, wherein in each of the sub-spaces, a pair of first electrodes are oppositely arranged on a surface of the first substrate adjacent to the dispersion and a surface of the second substrate adjacent to the dispersion so as to generate the vertical electric field; and a pair of second electrodes are oppositely arranged on the supporting material corresponding to each of the sub-spaces so as to generate the horizontal electric field.

6. The display panel according to claim 3, wherein a diffusion layer is arranged on one side of the first substrate away from the dispersion.

7. The display panel according to claim 3, wherein the first concentration is less than 1% by volume.

8. The display panel according to claim 2, wherein the concentration of the dispersion is a preset second concentration; and
the applied electric field comprises a horizontal electric field parallel to a plane where the substrate is located, and the birefringence of the two-dimensional material is controlled by the intensity of the horizontal electric field.

9. The display panel according to claim 8, wherein a first polarizing film is arranged on a surface of the first substrate away from the dispersion; and a second polarizing film is arranged on a surface of the second substrate away from the dispersion.

10. The display panel according to claim 8, wherein in each of the sub-spaces, a second electrode is arranged on a surface of the second substrate adjacent to the dispersion, and the second electrode comprises a pair of sub-electrodes arranged at an interval in a direction parallel to the plane where the second substrate is located so as to generate the horizontal electric field.

11. The display panel according to claim 8, wherein the second concentration is greater than 1% by volume.

12. The display panel according to claim 1, wherein the two-dimensional material comprises graphene oxide or graphene.

13. The display panel according to claim 1, wherein the value range of the thickness of the space between the first substrate and the second substrate is 20-40 μm.

14. The display panel according to claim 1, wherein the first substrate is a color film substrate and the second substrate is an array substrate.

15. A display device, comprising the display panel according to claim 1.
